(19) United States
(12) Patent Application Publication
(10) Pub. No.: US 2025/0289413 A1
(43) Pub. Date: Sep. 18, 2025

(54) METHOD AND SYSTEM OF CREATING PARKING MOTION FOR AUTONOMOUS VEHICLES

(71) Applicant: Yutaka John Kanayama, Dexter, MI (US)

(72) Inventor: Yutaka John Kanayama, Dexter, MI (US)

(21) Appl. No.: 19/063,651

(22) Filed: Feb. 26, 2025

Related U.S. Application Data
(63) Continuation-in-part of application No. 18/759,555, filed on Jun. 28, 2024, now abandoned.
Application No. 18/759,555 is a continuation-in-part of application No. 18/605,385, filed on Mar. 14, 2024, now abandoned.

(51) Int. Cl. B60W 30/06; B60W 60/00

(52) U.S. Cl. CPC B60W 30/06; B60W 60/001

(57) ABSTRACT

A method and system for controlling an autonomous vehicle during a parking motion is disclosed. The method includes receiving information, into a processor onboard the vehicle, from at least one sensor, calculating, via a processor onboard the vehicle, a starting vehicle position and a vehicle direction, calculating, via the processor onboard the vehicle, a goal parking position and a goal parking direction based upon the received information from the sensor, calculating, via the processor onboard the vehicle, a single arch or double arch motion based upon the starting vehicle position, the starting vehicle direction, the goal parking position, and the goal parking direction, and controlling the vehicle, via instructions provided by the processor onboard the vehicle, based upon the calculated single arch or double arch motion and the received information from the at least one sensor.

### CROSS REFERENCE TO RELATED APPLICATIONS

This application is a continuation-in-part of U.S. patent application Ser. No. 18/759,555, filed on Jun. 28, 2024, which is a continuation of U.S. patent application Ser. No. 18/605,385, filed on Mar. 14, 2024, the disclosures of which are incorporated herein by reference in their entirety.

### TECHNICAL FIELD

This disclosure relates to vehicle control, particularly to creating parking motion for autonomous vehicles.

### BACKGROUND

Autonomous vehicle control technology is a major area of innovation being worked on in the automotive industry, universities, and government agencies. Several reports say negative assessments of the latest research and development. Several companies announced that they would stop investing in this area.

Hence, there is a need for improved methods of autonomous vehicle control. FIG. 1 depicts geometric relationships in and around a four-way intersection, where a vehicle is supposed to arrive from the west into frame q₀. One of the purposes of this invention is for a vehicle to negotiate such an intersection, creating precise right turning: q₀→q₁, no turning: q₀→q₂, or left turning: q₀→q₃. Several reports mentioned that the latest technology has difficulty turning left at intersections, causing jams and accidents.

Furthermore, there were no reports that an autonomous vehicle parks itself exactly in a parking slot bounded by white lines, either head-in or back-in, in a large shopping center parking lot. Once a vehicle leaves its garage, it must eventually park and stop at a particular place, switching the heading orientation from forward to backward and vice versa.

### SUMMARY

Method of controlling an autonomous vehicle during a parking motion are disclosed. The method includes controlling a vehicle from start to goal, forward or backward, using a single-arch or double-arch motion, and minimizing the total motion cost. This method creates parking motion that controls a vehicle by two control variables (v, k)=(velocity, path curvature).

Stereo vision is mostly appropriate for sensors in this vehicle motion-creation method. For instance, in FIG. 1, the sensor installed on the vehicle positioned at q₀ senses the distances and orientations to center lines, boundaries of lanes, crossing lines, the walking way, and others. Then, we can compute the exact frames of q₁, q₂, or q₃ using the two-dimensional transformation theory.

### BRIEF DESCRIPTION OF THE DRAWINGS

FIG. 1 depicts a four-way intersection, where a vehicle arrives from the west and makes turns.

FIG. 2 depicts a vehicle frame (p, θ)=((x, y), θ) in the global coordinate system.

FIG. 3 illustrates how the composition operation works.

FIG. 4 illustrates that two frames form a mate.

FIG. 5 is an arch curvature function K sin (πs/S) graph.

FIG. 6 showcases four arches with several end angles φ with S=200.

FIG. 7 showcases four arches with several end angles φ with S=200.

FIG. 8 describes the geometry of an arch around its midpoint.

FIG. 9 illustrates two similar arches.

FIG. 10 illustrates an arch and its cord D.

FIG. 11 is the arch-code ratio Σ(φ) table for φ=0° to 279° at an interval of 1°.

FIG. 12 showcases single-arch motions, forward (left) and backward (right).

FIG. 13 illustrates a parallel case, a common mate, and the common-mate line.

FIG. 14 illustrates two forward parallel motions.

FIG. 15 illustrates a backward parallel motion.

FIG. 16 depicts the pivot of (start, goal)=(q₀, q₁) in the general case.

FIG. 17 describes the external-angle lemma.

FIG. 18 describes a common-mate circle on a pivot.

FIG. 19 illustrates the flowchart of a function, getLeastCostCommonMate (start, goal), that returns a least-cost common mate.

FIG. 20 outlines an entire algorithm for a parking motion including three situations about (start, goal).

FIG. 21 showcases two general-case solutions, forward and backward.

FIG. 22 showcases three forward-parking motions with common mates in general cases.

FIG. 23 showcases three backward-parking motions with common mates in general cases.

FIG. 24 describes the kinematics of a car-like vehicle.

FIG. 25 illustrates a computer system architecture that embodies the parking-motion teaching.

FIG. 26 depicts an example situation, parallel parking, for executing a single arch or double arch motion.

FIG. 27 depicts further parking examples, a forward parking event and a backward parking event for executing a single arch or double arch motion.

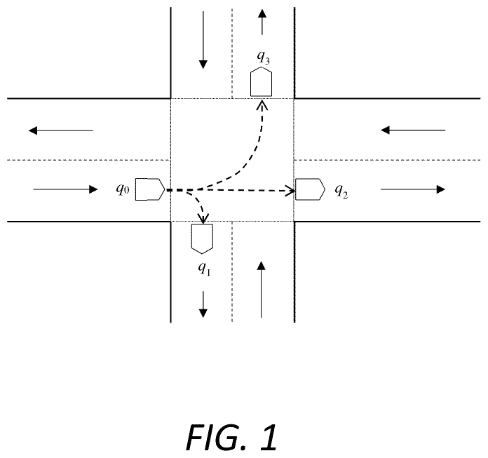

### DETAILED DESCRIPTION

### 1. The 2D Transformation Theory

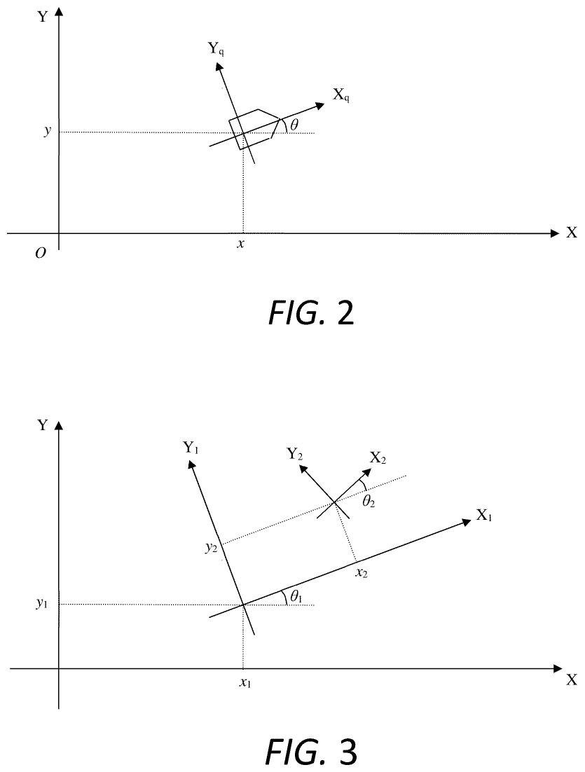

This theory provides elementary arithmetic in positioning and moving two-dimensional rigid body vehicles. We define a Cartesian coordinate system (X, Y) in the Autonomous Vehicle (AV) playground. In the Cartesian coordinate system, we call the pair of a vehicle position (x, y) and a vehicle heading direction θ a frame: q=((x, y), θ), with real numbers x, y, and θ. (FIG. 2) The same mathematical structure q=((x, y), θ) may represent a 2D transformation. The transformation ((x, y), θ) is a composition of two elementary transformations sequentially: a translation ((x, y), 0) and a rotation ((0, 0), θ) in this order. (FIG. 3).

### 2. Transformations and Their Composition

Let T denote the set of all transformations. Let q₁ and q₂ be two transformations in T, q₁=((x₁, y₁), q₁) and q₂=((x₂, y₂), q₂). We define their composition q₁·q₂ as follows:

$${q}_{1} \cdot {q}_{2} = ( ( {x}_{1} , {y}_{1} ) , {q}_{1} ) \cdot ( ( {x}_{2} , {y}_{2} ) , {q}_{2} ) = ( ( {x}_{1} + {x}_{2} cos {q}_{1} - {y}_{2} sin {q}_{1} , {y}_{1} + {x}_{2} sin {q}_{1} + {y}_{2} cos {q}_{1} ) , {q}_{1} + {q}_{2} ) \qquad ( 2.1 )$$

Then, q₁·q₂ is also a transformation. FIG. 3 shows the geometrical interpretation of the composition operation.

Lemma 2.1 (Associativity): The following equality holds for any transformations q₁, q₂, and q₃ in T:

$$( {q}_{1} \cdot {q}_{2} ) \cdot {q}_{3} = {q}_{1} \cdot ( {q}_{2} \cdot {q}_{3} ) \qquad ( 2.2 )$$

(2.3) Identity: If q₀·q=q·q₀=q holds for any q in T, we call the transformation q₀ identity transformation.
Lemma 2.2 (Identity): A transformation e=((0, 0), 0) in T is an identity transformation.
(2.4) Inverse: Let us define the inverse transformation of a given transformation q. For a transformation q in T, if q₁ in T satisfies an equality q·q₁=q₁·q=e, we call q₁ the inverse of q, q⁻¹.
Lemma 2.3 (Inverse): For a transformation q=((x, y), θ) in T, its inverse q⁻¹ exists:

$${q}^{- 1} = ( ( - x cos θ - y sin θ , x sin θ - y cos θ ) , - θ ) \qquad ( 2.5 )$$

### 3. Transformation Group

Theorem 3: Transformation Group: The set T of transformations forms a non-abelian group under the composition operation (·) because (a) T is closed under the composition operation (·); (b) The composition is associative by Lemma 2.1; (c) There exists an identity e in T by Lemma 2.2; (d) An inverse transformation q⁻¹ exists for any transformation q by Lemma 2.3. QED

### 4. Mate: a Binary Relation Between Two Frames

Let q₀≡(p₀, θ₀)≡((x₀, y₀), θ₀) and q₁≡(p₁, θ₁)≡((x₁, y₁), θ₁) be two frames with p₀≠p₁, and let α be the direction from position p₀ to position p₁. If

$$( α - {θ}_{0} ) + ( α - {θ}_{1} ) = 0 \qquad ( 4.1 )$$

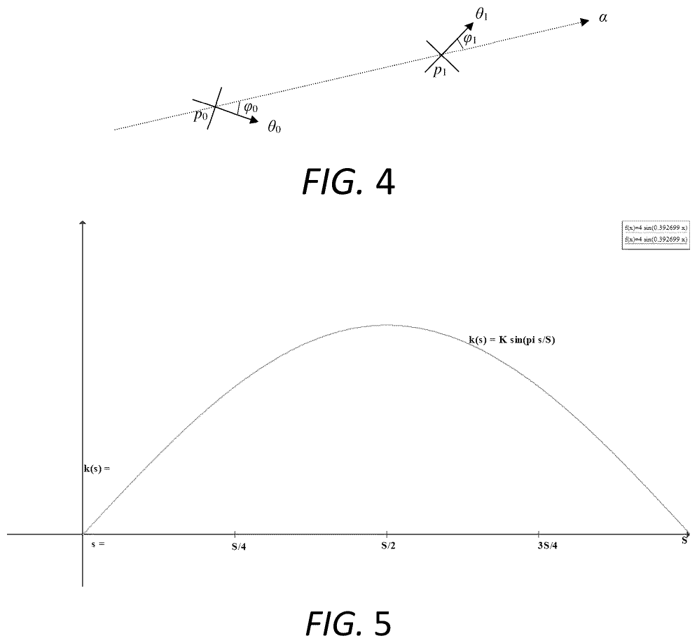

holds, we call the frame pair <q₀, q₁> a mate. (FIG. 4)

### 5. Curves and Arches

We define a curve by a continuous curvature function k of arc length s and a total length S:

$$κ = κ ( s ) , 0 \leq s \leq S or S \leq s \leq 0 \qquad ( 5.1 )$$

We call a curve k(s) that satisfies the following equation an arch:

$$κ ( s ) = K sin ( \frac{π s}{s} ) , 0 \leq s \leq S or S \leq s \leq 0 \qquad ( 5.2 )$$

where K is the maximum curvature, and S is the total arc length. The parameters S and K are positive or negative. An arch's curvature function k(s) is shown in FIG. 5, a familiar sinusoidal function. Let us compute the direction θ(t) of an arch at s=t using (5.2),

$$θ ( t ) = {\int }_{0}^{t} K sin ( \frac{π s}{S} ) ds = {\frac{KS}{π} [ - cos ( \frac{π s}{S} ) ]}_{0}^{t} ds = \frac{KS}{π} ( 1 - cos ( \frac{π t}{S} ) ) \qquad ( 5.3 )$$

We call the difference θ₁−θ₀ between the end directions θ₁ and θ₀ the end angle φ of an arch. An end angle φ is either positive or negative. Therefore,

$$φ = {θ}_{1} - {θ}_{0} = θ ( S ) = {\int }_{0}^{S} K sin ( \frac{π s}{S} ) d s = \frac{2 KS}{π} \qquad ( 5.3 )$$

### Therefore,

$$K = \frac{π}{2 S} φ or KS = \frac{πφ}{2} \qquad ( 5.4 )$$

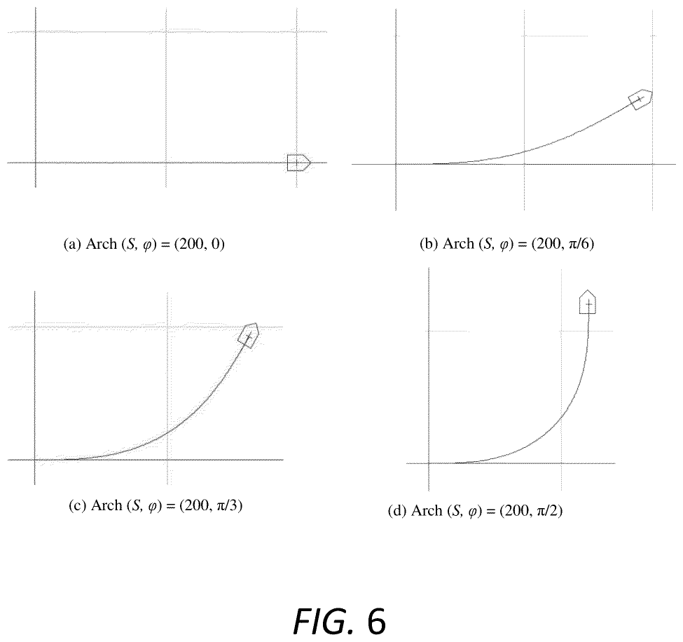

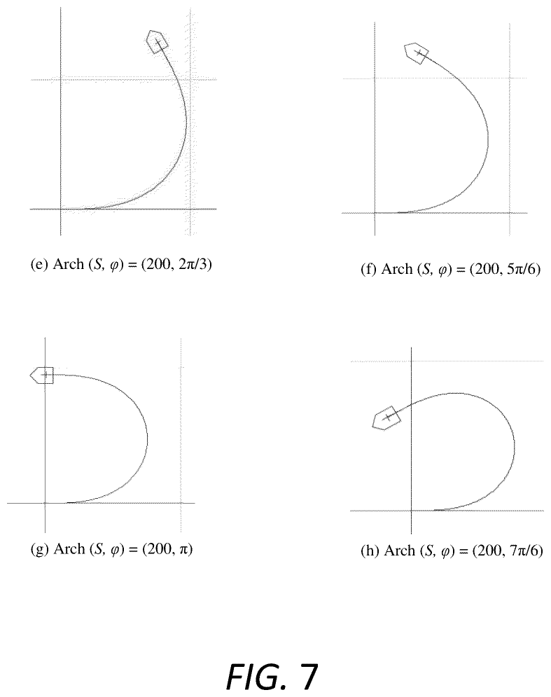

FIG. 6: Four arches with S=200, and φ=0, πx/6, π/3, and π/2
FIG. 7: Four arches with S=200, and φ=2π/3, 5π/6, π, and 7π/6

### 6. Cost of Curves and Arches

We define the cost (or complexity) Γ of a curve k(s) as:

$$Γ ( κ ( s ) ) = {\int }_{0}^{S} {( \frac{dk ( s )}{ds} )}^{2} d s , 0 \leq s \leq S \qquad ( 6.1 )$$

### Then,

Theorem 6. The cost of an arch

$$κ ( s ) = K sin ( \frac{π s}{S} ) ,$$

0≤s≤S, is equal to

$$Γ ( κ ( s ) ) = \frac{{π}^{4}}{8} \frac{{φ}^{2}}{{s}^{3}} .$$

### Proof

We obtain the curvature function's derivative and its square:

$$\begin{matrix}\frac{d κ ( s )}{d s} = \frac{π K}{S} cos ( \frac{π s}{S} ) \\ {( \frac{d k}{d s} )}^{2} = \frac{{π}^{2} {K}^{2}}{{S}^{2}} {cos}^{2} ( \frac{π s}{S} ) = \frac{{π}^{2} {K}^{2}}{2 {S}^{2}} ( 1 + cos ( \frac{2 π s}{S} ) )\end{matrix}$$

We integrate the last equation from s=0 to s=S to obtain the arch cost:

$$Γ = {\int }_{0}^{S} {( \frac{d k}{d s} )}^{2} d s = \frac{{π}^{2} {K}^{2}}{2 S} + \frac{{π}^{2} {K}^{2}}{2 {S}^{2}} {\int }_{0}^{S} cos ( \frac{2 π s}{S} ) ds = \frac{{π}^{2} {K}^{2}}{2 S} = \frac{{{π}^{2} ( \frac{πφ}{2 S} )}^{2}}{2 S} = \frac{{π}^{4}}{8} \frac{{φ}^{2}}{{S}^{3}}$$

### QED

### 7. An Arch Creates a M ate

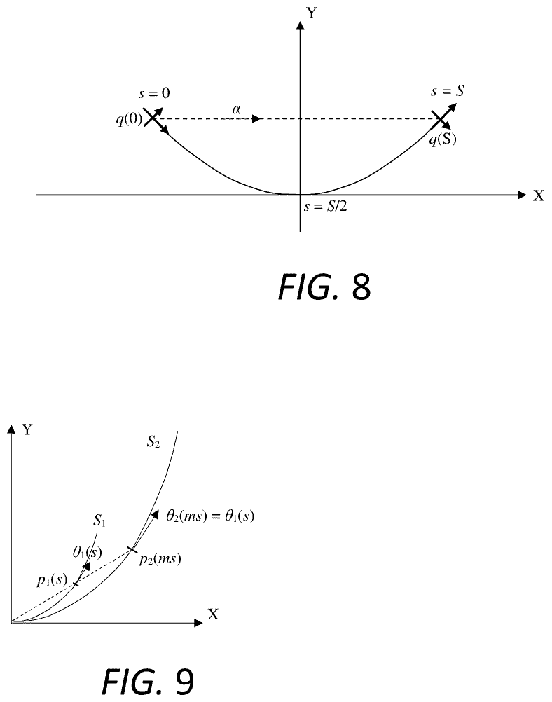

FIG. 8 depicts the situation around an arch K(s) at its midpoint, s=S/2. The coordinate system is transformed to global ((0, 0), 0) at the midpoint of the arch.

Lemma 7.1: Let θ(t) be the tangential direction of an arch k(s) at s=t in the new coordinate system. For any t with 0≤t≤S,

$$\frac{θ ( t ) + θ ( S - t )}{2} = θ ( \frac{s}{2} ) = 0 \qquad ( 7.1 )$$

### Proof

Let 0≤t≤S/2. Then,

$$\begin{matrix}θ ( t ) = {\int }_{0}^{t} k ( s ) ds = {\int }_{0}^{\frac{S}{2}} k ( s ) ds - {\int }_{\frac{S}{2}}^{t} k ( s ) ds = - {\int }_{\frac{S}{2}}^{t} κ ( s ) ds = A . \\ θ ( S - t ) = {\int }_{0}^{S - t} k ( s ) ds = {\int }_{0}^{\frac{S}{2}} k ( s ) + {\int }_{\frac{S}{2}}^{S - t} k ( s ) d s = {\int }_{\frac{S}{2}}^{S - t} κ ( s ) d s = B .\end{matrix}$$

However, the integrals A and B must be equal because of the symmetric property of curvature (5.2). Thus, Lemma 7.1 is proven.

### QED

Theorem 7: An arch's initial and end frames, q(0) and q(S), form a mate.

### Proof

FIG. 8 shows an arch after applying a transformation such that its mid-frame q(S/2) is ((0, 0), 0). Namely,

$$x ( \frac{S}{2} ) = y ( \frac{S}{2} ) = θ ( \frac{S}{2} ) = 0.$$

Then, by Lemma 8.1, θ(t)+θ(S−t)=0 and θ(S−t)=−θ(t) for any t with 0≤t≤S.
   I. Proving that (7.2) x(t)=−x (S−t) for any t with 0≤t≤S.

$$x ( t ) = {\int }_{0}^{𝔱} cos ( θ ( s ) ) ds = {\int }_{0}^{\frac{S}{2}} cos ( θ ( s ) ) d s - {\int }_{\frac{S}{2}}^{𝔱} cos ( θ ( s ) ) d s = x ( \frac{S}{2} ) - {\int }_{\frac{S}{2}}^{𝔱} cos ( θ ( s ) ) d s = - {\int }_{\frac{S}{2}}^{𝔱} cos ( θ ( s ) ) d s$$

Because we know that x(S/2)=0. Next,

$$x ( S - t ) = {\int }_{0}^{S - 𝔱} cos ( θ ( s ) ) ds = {\int }_{0}^{\frac{S}{2}} cos ( θ ( s ) ) d s - {\int }_{\frac{S}{2}}^{S - 𝔱} cos ( θ ( s ) ) d s = x ( \frac{S}{2} ) - {\int }_{\frac{S}{2}}^{S - 𝔱} cos ( θ ( s ) ) ds = {\int }_{\frac{S}{2}}^{S - 𝔱} cos ( θ ( s ) ) d s$$

Let u=S−s. Then du=−ds:

$${\int }_{\frac{S}{2}}^{S - 𝔱} cos ( θ ( s ) ) d s = {\int }_{\frac{S}{2}}^{t} cos ( θ ( S - u ) ) ( - d u ) = - {\int }_{\frac{S}{2}}^{t} cos ( - θ ( u ) ) du = {\int }_{\frac{S}{2}}^{t} cos ( θ ( u ) ) d u$$

Therefore, we proved (7.2) x(t)=−x (S−t) for any t with 0≤t≤S.
II. Proving that (7.3) y(t)=y (S−t) for any t with 0≤t≤S.

$$y ( t ) = {\int }_{0}^{t} sin ( θ ( s ) ) ds = {\int }_{0}^{\frac{s}{2}} sin ( θ ( s ) ) ds - {\int }_{\frac{s}{2}}^{t} sin ( θ ( s ) ) d s = y ( \frac{s}{2} ) - {\int }_{\frac{s}{2}}^{t} sin ( θ ( s ) ) = - {\int }_{\frac{s}{2}}^{t} sin ( θ ( s ) ) d s ,$$

because y(S/2)=0. Furthermore,

$$y ( S - t ) = {\int }_{0}^{S - t} sin ( θ ( s ) ) ds = {\int }_{0}^{\frac{S}{2}} sin ( θ ( s ) ) ds + {\int }_{\frac{S}{2}}^{S - t} sin ( θ ( s ) ) ds = y ( \frac{S}{2} ) + {\int }_{\frac{S}{2}}^{S - t} sin ( θ ( s ) ) d s = {\int }_{\frac{S}{2}}^{S - t} sin ( θ ( s ) ) d s$$

Let u=S−s or s=S−u. Then du=−ds:

$${\int }_{\frac{S}{2}}^{S - t} sin ( θ ( s ) ) ds = {\int }_{\frac{S}{2}}^{S - t} sin ( θ ( S - s ) ) ds = - {\int }_{\frac{S}{2}}^{t} sin ( θ ( u ) ) ( - du ) = {\int }_{\frac{S}{2}}^{t} sin ( θ ( u ) ) du = {\int }_{0}^{\frac{S}{2}} sin ( θ ( u ) ) du - {\int }_{t}^{\frac{S}{2}} sin ( θ ( u ) ) = - {\int }_{t}^{\frac{S}{2}} sin ( θ ( u ) ) du = y ( S - t )$$

Therefore, y(t)=y(S−t) for any t with 0≤t≤S. Therefore, the direction α from the initial endpoint p(0) to the last endpoint p(S) is 0. Furthermore, θ(0)=−θ(S) by Lemma 7.1. Because α=0, (α−θ(0))+(α−θ(0))=−(θ(0)+θ(S))=0. Therefore, both end frames of an arch form a mate pair.

### QED

### 8. Similarity of Arches

We consider two arches, k₁(s) and k₂(s), as follows (FIG. 9):

$${κ}_{1} ( s ) = {K}_{1} sin ( \frac{π s}{{S}_{1}} ) , 0 \leq s \leq {S}_{1} \qquad ( 8.1 )$$

$${k}_{2} ( s ) = {K}_{2} sin ( \frac{π s}{{S}_{2}} ) , 0 \leq s \leq {S}_{2} \qquad ( 8.2 )$$

$${K}_{1} {S}_{1} = {K}_{2} {S}_{2} \qquad ( 8.3 )$$

Since K₁S₁=K₂S₂, K₁/K₂=S₂/S₁, the above two arches have an identical end angle φ because of (5.4). If we let S₂/S₁=m for some m, S₂=mS₁ and K₂=K₁/m.

Lemma 8: As to the two arches given by Equations (8.1), (8.2), and (8.3), the following equality regarding tangential directions θ₁ and θ₂ holds for any u such that 0≤u≤S₁:

$${θ}_{1} ( u ) = {θ}_{2} ( mu ) \qquad ( 8.4 )$$

### Proof

Let us define a variable t=ms and dt=mds. Then, using this variable conversion,

$${θ}_{2} ( mu ) = {\int }_{0}^{m u} {κ}_{2} ( t ) dt = {\int }_{0}^{m u} {K}_{2} sin ( \frac{π t}{{S}_{2}} ) dt = {\int }_{0}^{u} \frac{{K}_{1}}{m} sin ( \frac{π ms}{{mS}_{1}} ) mds = {\int }_{0}^{u} {K}_{1} sin ( \frac{π s}{{S}_{1}} ) ds = {\int }_{0}^{u} {K}_{1} ( s ) ds = {θ}_{1} ( u )$$

### QED

Theorem 8 (Similarity): Let arches k₁ and k₂ defined by Equations (8.1), (8.2), and (8.3). Then, the following equations hold for any u such that 0≤u≤S:

$${mx}_{1} ( u ) = {x}_{2} ( mu ) \qquad ( 8.5 )$$

$${my}_{1} ( u ) = {y}_{2} ( mu ) \qquad ( 8.6 )$$

Therefore, we have proven that the two arches are similar.

### Proof

We define a variable t=ms, dt=mds. Using Equations (8.4), we have

$${x}_{2} ( mu ) = {\int }_{0}^{m u} c o s ( {θ}_{2} ( t ) ) dt = {\int }_{0}^{m u} cos ( {θ}_{1} ( \frac{t}{m} ) ) dt = {\int }_{0}^{u} cos ( {θ}_{1} ( s ) ) mds = m {\int }_{0}^{u} cos ( {θ}_{1} ( s ) ) ds = {mx}_{1} ( u )$$

Likewise, we have y₂(mu)=my₁(u). Therefore, the two arches are similar.

### QED

### 9. The Cord of an Arch

We revisit the arch equation:

$$κ ( s ) = K sin ( \frac{π s}{S} ) , 0 \leq s \leq S \qquad ( 9.1 )$$

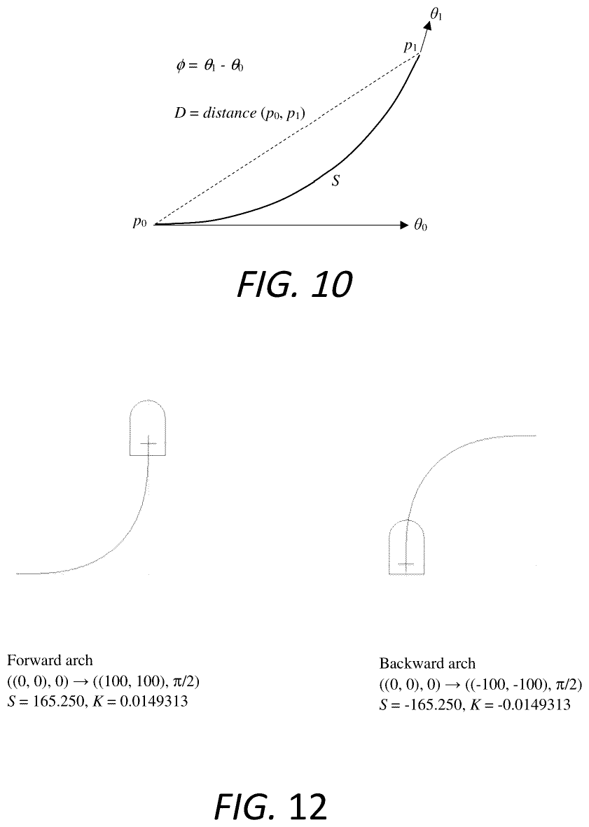

We call the distance between the two endpoints of an arch the cord D. (FIG. 10) The absolute value |S| of the total arc length S and cord D are proportional. We define the arch-cord ratio Σ(φ) as follows:

$$\sum ( φ ) = S / D \qquad ( 9.2 )$$

Σ(0)=1, and for all other φ, Σ(φ)>1. Σ(φ) monotonically increases over φ because cord monotonically decreases over φ. Therefore, if we have a cord D and end angle φ, we obtain S as

$$S = D \sum ( φ ) \qquad ( 9.3 )$$

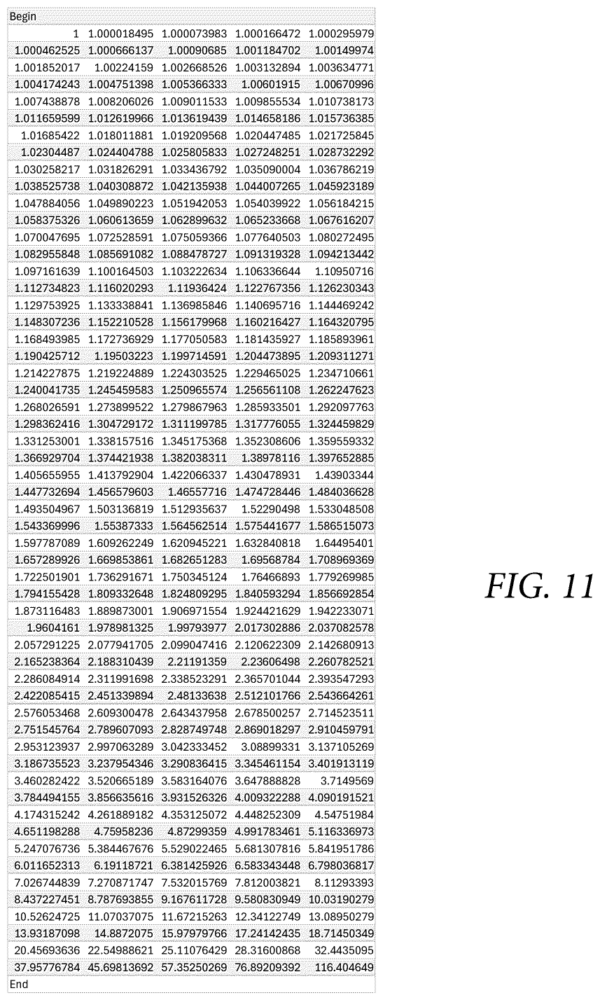

We computed arch-code ratios Σ(φ) offline for φ=0° to 279° at an interval of 1° as shown in FIG. 11.

10. Creating a Single-Arch Motion for a mate <qₐ, q_{b}>, based on qₐ=(pₐ, θₐ)=((xₐ, yₐ), θₐ), and q_{b}=(p_{b}, θ_{b})=((x_{b}, y_{b}), θ_{b}):

If a parking problem input <qₐ, q_{b}> is a mate, Theorem 7 tells us we can create an arch that connects both end frames qₐ and q_{b} as the solution.
1. Let φ=θ_{b}−θₐ.
2. With interpolation, obtain Σ(φ) by looking up FIG. 11 arch-cord-ratio.
3. Let D=distance (pₐ, p_{b}).
4. Let S=D Σ(φ) from (9.3).
5. If vehicle orientation is backward, let S=−D Σ(φ).
6. Let

$$K = \frac{πφ}{2 S} from ( 5.3 ) .$$

The above method creates an arch motion with parameters S, and K. FIG. 12 showcases single-arch motions, forward (left) and backward (right).

### 12. Solution for Parallel Case: θ₀=θ₁

Now, we give the least-cost solution for parallel cases.

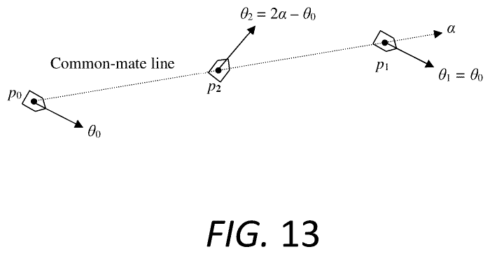

Lemma 12: Common mate in parallel case: Let start=q₀=(p₀, θ₀) and goal=q₁=(p₁, θ₁) be two given frames with p₀·p₁ and θ₀=θ₁. Let α be the direction from p₀ to p₁, and let p₂ be an arbitrary point on p₀p₁. Then, the following frame q₂ is a common mate of q₀ and q₁ (FIG. 13).

$${q}_{2} = ( {p}_{2} , {θ}_{2} ) = ( {p}_{2} , 2 α - {θ}_{0} ) \qquad ( 12.1 )$$

### Proof

Because (α−θ₀)+(α−θ₂)=2α−θ₀−(2α−θ₀)=0, q₀ and q₂ are mate.

Because (α−θ₂)+(α−θ₁)=2α−(2α−θ₀)−θ₁=0, q₂ and q₁ are mate.

We call this line p₀p₁ a common-mate line.

### QED

Using the above q₂, we have a two-arch parking solution using arch A, which is defined by q₀ and q₂, and arch B, which is defined by q₂ and q₁. However, we have the best solution, as follows:

Theorem 12: Let start=(p₀, θ₀) and goal=(p₁, θ₁) be two given frames with p₀≠p₁ and θ₀=θ₁. Let α be the direction from p₀ to p₁, and let p₂ be an arbitrary point on line p₀p₁. Then, the frame

$${q}_{2} = inflection = ( ( ( {x}_{0} + {x}_{1} ) / 2 , ( {y}_{0} + {y}_{1} ) / 2 ) , 2 α - {θ}_{0} ) \qquad ( 12.2 )$$

produces the minimal-cost parking solution for (start, goal).

### Proof

We assume that an arbitrary mate q₂ is taken on the common-mate line. The motion we obtain via q₂ consists of two arches for <q₀, q₂> and <q₂, q₁>. From Theorem 6, the total cost C of the two arches is:

$$C = ( \frac{{π}^{4}}{8} ) ( \frac{{φ}_{0}^{2}}{{S}_{0}^{3}} + \frac{{φ}_{1}^{2}}{{S}_{1}^{3}} ) , \qquad ( 12.3 )$$

where S₀ and S₁ are their total arc lengths of arches, and φ₀ and φ₁ are their end angles. In this case, the equations below hold:

$${φ}_{0} = ( 2 α - {θ}_{0} ) - {θ}_{0} = 2 ( α - {θ}_{0} ) = constant$$

$${φ}_{1} = {θ}_{1} - ( 2 α - {θ}_{0} ) = {θ}_{1} + {θ}_{0} - 2 α = 2 {θ}_{0} - 2 α = 2 ( {θ}_{0} - α ) = constant$$

Because φ₀²=φ₁²=constant, minimizing C in (12.3) is equivalent to minimizing C′ in the following equation:

$${C}^{′} = \frac{1}{{S}_{0}^{3}} + \frac{1}{{S}_{1}^{3}} \qquad ( 12.4 )$$

Let z be distance (p₀, p₂) and Z be distance (p₀, p₁), where Z is a constant. Then, S₀ and S₁ are proportional to z and Z−_{z}, respectively (Section 9). Therefore, finding a common mate that minimizes the cost C′ in (13.2) is equivalent to finding z that minimizes the following C″:

$${C}^{″} = \frac{1}{{z}^{3}} + \frac{1}{{( Z - z )}^{3}} \qquad ( 12.5 )$$

The derivative of C″ for z is:

$$\begin{matrix}\frac{{dC}^{″}}{dz} = \frac{- 3}{{z}^{4}} - \frac{- 3}{{( Z - z )}^{4}} = \frac{3}{{( Z - z )}^{4} {z}^{4}} [ {z}^{4} - {( Z - z )}^{4} ] = \frac{3}{{( Z - z )}^{4} {z}^{4}} [ ( {z}^{2} + {( Z - z )}^{2} ) ] [ {z}^{2} - {( Z - z )}^{2} ] \\ = \frac{3}{{( Z - z )}^{4} {z}^{4}} [ ( {z}^{2} + {( Z - z )}^{2} ) ] [ ( 2 z - Z ) Z ]\end{matrix}$$

Then, if z<Z/2, dC′/dz<0; otherwise, dC′/dz>0. Therefore, z=Z/2 minimizes C″. Thus, we obtain the least-cost common mate if it is a midpoint.

### QED

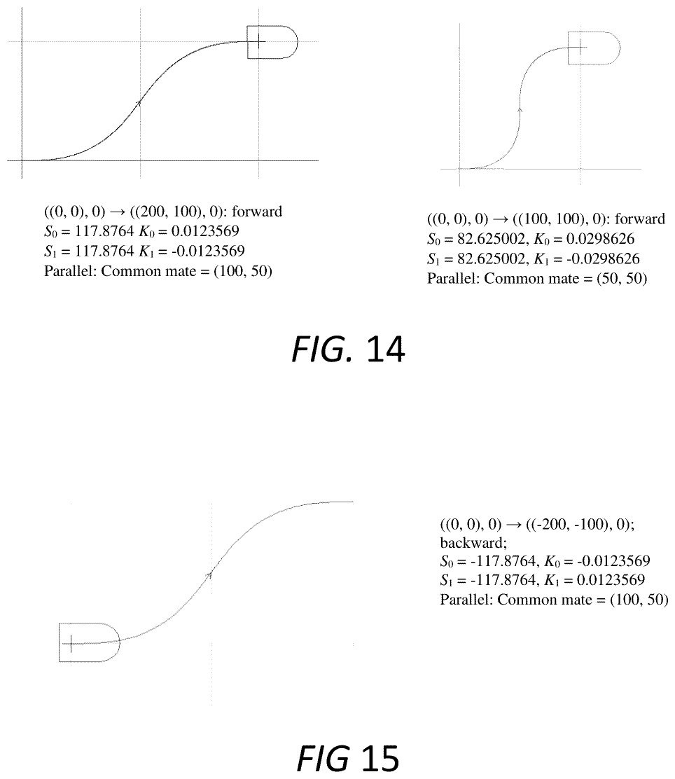

This method gives us sample solutions, which are presented in FIG. 14: parallel forward and in FIG. 15: parallel backward. An arrowhead on each trajectory indicates the common mate (or inflection point), where the curvature sign switches.

### 13. Pivot

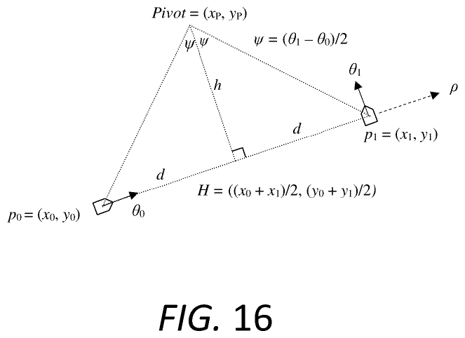

Let start=(p₀, θ₀)=((x₀, y₀), θ₀) and goal=(p₁, θ₁)=((x₁, y₁), θ₁) be two frames with p₀≠p₁ and θ₁≠θ₀. Then, there exists a point P such that P is equidistant from p₀ and p₁, and the signed angle/p₀Pp₁=θ₁−θ₀=2ψ. We call that point P the pivot of start and goal. (FIG. 16)

### Lemma 13: Pivot Lemma

The coordinates of Pivot P are:

$$P = [ \begin{matrix}{x}_{P} \\ {y}_{P}\end{matrix} ] = [ \begin{matrix}\frac{{x}_{0} + {x}_{1}}{2} - \frac{{y}_{1} - {y}_{0}}{2} cot ψ \\ \frac{{y}_{0} + {y}_{1}}{2} + \frac{{x}_{1} - {x}_{0}}{2} cot ψ\end{matrix} ] , \qquad ( 13.1 )$$

where ψ=(θ₁−θ₀)/2.

### Proof

In FIG. 16, H is the midpoint

$$( \frac{{x}_{0} + {x}_{1}}{2} , \frac{{y}_{0} + {y}_{1}}{2} )$$

of p₀ and p₁. Let ρ be the direction from p₀ to p₁, and 2d be the distance of p₀p₁. Let h=HP denote a signed height of Δp₀Pp₁.

### Then,

$$sin ρ = \frac{{y}_{1} - {y}_{0}}{\sqrt{{( {x}_{1} - {x}_{0} )}^{2} + {( {y}_{1} - {y}_{0} )}^{2}}}$$

$$cos ρ = \frac{{x}_{1} - {x}_{0}}{\sqrt{{( {x}_{1} - {x}_{0} )}^{2} + {( {y}_{1} - {y}_{0} )}^{2}}}$$

$${p}_{0} H = d = {p}_{0} {p}_{1} / 2 = \frac{1}{2} \sqrt{{( {x}_{1} - {x}_{0} )}^{2} + {( {y}_{1} - {y}_{0} )}^{2}}$$

$$HP = h = \frac{d}{tan ψ} = \frac{1}{2} \sqrt{{( {x}_{1} - {x}_{0} )}^{2} + {( {y}_{1} - {y}_{0} )}^{2}} cot ψ$$

### Then,

$${x}_{P} = \frac{{x}_{0} + {x}_{1}}{2} + h cos ( ρ + \frac{π}{2} ) = \frac{{x}_{0} + {x}_{1}}{2} - h sin ρ = \frac{{x}_{0} + {x}_{1}}{2} - \frac{1}{2} \sqrt{{( {x}_{1} - {x}_{0} )}^{2} + {( {y}_{1} - {y}_{0} )}^{2}} cot ψ \frac{{y}_{1} - {y}_{0}}{\sqrt{{( {x}_{1} - {x}_{0} )}^{2} + {( {y}_{1} - {y}_{0} )}^{2}}} = \frac{{x}_{0} + {x}_{1}}{2} - \frac{{y}_{1} - {y}_{0}}{2} cot ψ$$

$${y}_{P} = \frac{{y}_{0} + {y}_{1}}{2} + h sin ( ρ + \frac{π}{2} ) = \frac{{y}_{0} + {y}_{1}}{2} + h cos ρ = \frac{{y}_{0} + {y}_{1}}{2} + \frac{1}{2} \sqrt{{( {x}_{1} - {x}_{0} )}^{2} + {( {y}_{1} - {y}_{0} )}^{2}} cot ψ \frac{{x}_{1} - {x}_{0}}{\sqrt{{( {x}_{1} - {x}_{0} )}^{2} + {( {y}_{1} - {y}_{0} )}^{2}}} = \frac{{y}_{0} + {y}_{1}}{2} + \frac{{x}_{1} - {x}_{0}}{2} cot ψ$$

### QED

### 14. Solving Parking Problems in General Case

Let start=(p₀, θ₀)=((x₀, y₀), θ₀) and goal=(p₁, θ₁)=((x₁, y₁), θ₁) be two frames with p₀≠p₁ and θ₁≠θ₀. Consider a circle defined by three points, pivot P, p₀, and p₁, with P as its center. We call this circle the pivot circle.

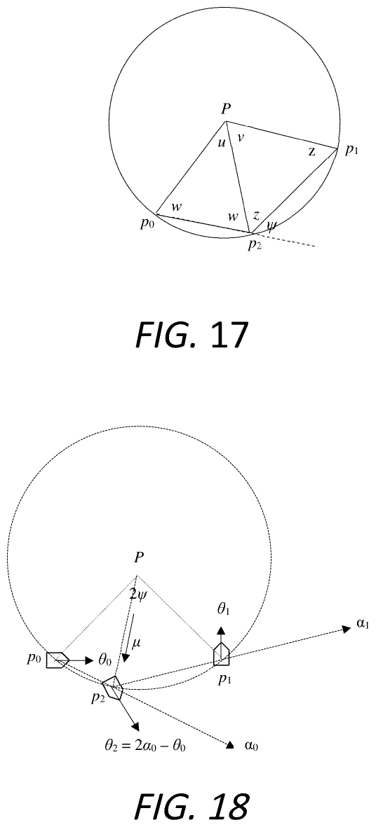

Lemma 14.1: (External-Angle Lemma): Let start=(p₀, θ₀) and goal=(p₁, θ₁) be two frames with p₀≠p₁ and θ₁≠θ₀. Let P be the pivot of start and goal. Let ψ=(θ₁−θ₀)/2, and p₂ be an arbitrary point on the pivot circle between p₀ and p₁. (FIG. 17) Then,

$$\underline{/} {p}_{0} {p}_{2} {p}_{1} = π - ψ \qquad ( 14.1 )$$

### Proof

We name the angles u, v, w, and z, as shown in FIG.17. Then, we have

$$u + 2 w = π$$

$$v + 2 z = π$$

By adding both sides up, we obtain

$$u + v + 2 ( w + z ) = 2 π$$

$$or$$

$$w + z = π - ( u + v ) / 2 = π - 2 ψ / 2 = π - ψ .$$

### QED

### Theorem 14.1 (Common-Mate Theorem in the General Case)

Let q₀=(p₀, θ₀) and q₁=(p₁, θ₁) be two given frames with p₀≠p₁ and θ₀≠θ₁, and P be the pivot of q₀ and q₁. Furthermore, let p₂ be an arbitrary point on the pivot circle, α₀ be the line from p₀ to p₂, and α₁ be the line from p₂ to p₁, as shown in FIG.18. Then, q₂=(p₂, θ₂)=(p₂, 2α₀−θ₀,) is a common mate of q₀ and q₁. (Further, let μ be the direction from P to p₂.)

### Proof

Part I: Prove that <q₀, q₂> is a mate.

Because θ₂=2α₀-θ₀, then

$$( {α}_{0} - {θ}_{0} ) + ( {α}_{0} - {θ}_{2} ) = {α}_{0} - {θ}_{0} + {α}_{0} - ( 2 {α}_{0} - {θ}_{0} ) = 0.$$

Therefore, <q₀, q₂> is a mate.

Part II: Prove that <q₂, q₁> is a mate.

$$( {α}_{1} - {θ}_{2} ) + ( {α}_{1} - {θ}_{1} ) = {α}_{1} - ( 2 {α}_{0} - {θ}_{0} ) + {α}_{1} - {θ}_{1} = 2 {α}_{1} - 2 {α}_{0} - {θ}_{1} + {θ}_{0} = 2 ( {α}_{1} - {α}_{0} - ( {θ}_{1} - {θ}_{0} ) ) = 2 ( {α}_{1} - {α}_{0} - ψ )$$

On the other hand, by External-Angle Lemma, α₁−α₀=(θ₁−θ₀)/2=ψ. Therefore, <q₂, q₁> is a mate.

### QED

When a common mate (or inflection point) is found, we can create a two-arch motion with two arches <start, inflection> and <inflection, goal> as a solution. The following Theorem finds the best inflection that the sum of the cost of two arches minimized:

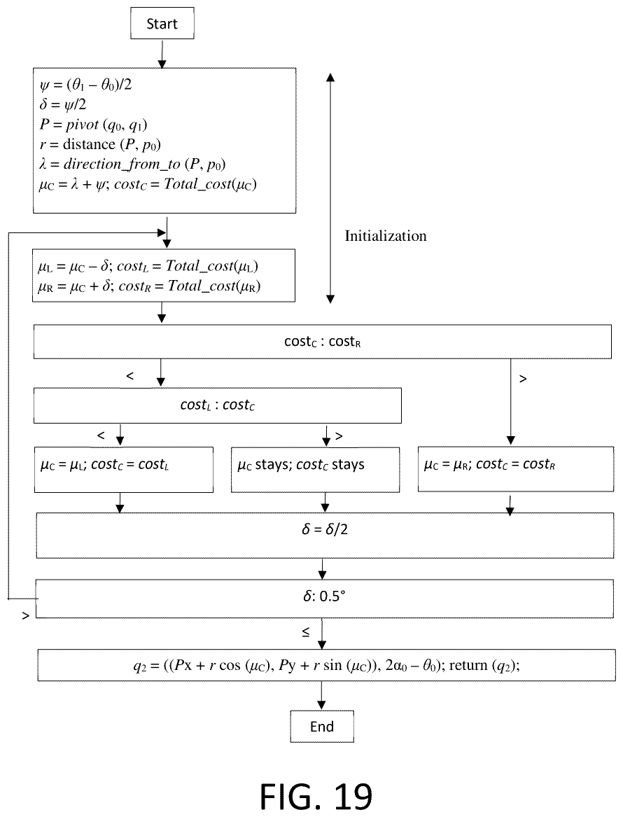

Theorem 14.2 (searching in general case) The algorithm depicted in FIG. 19 searches for the least-cost common mate.

### 15. An Outline of the Entire Parking-Motion Algorithm

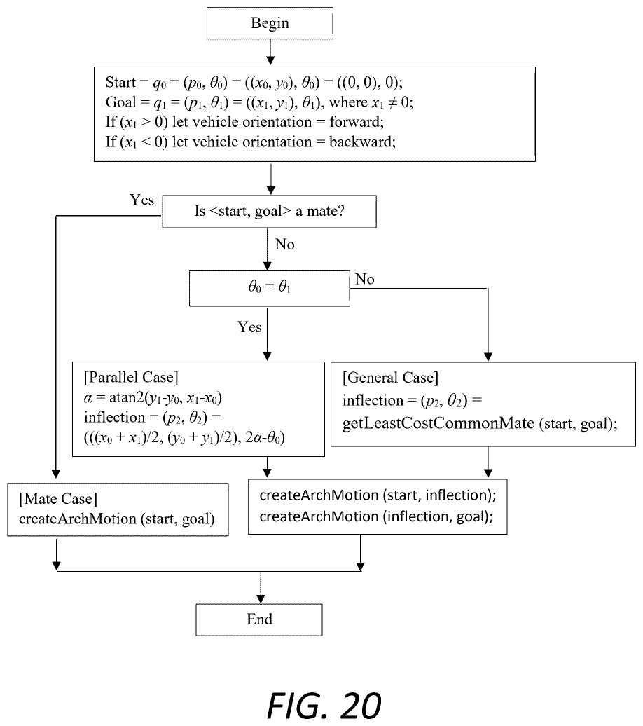

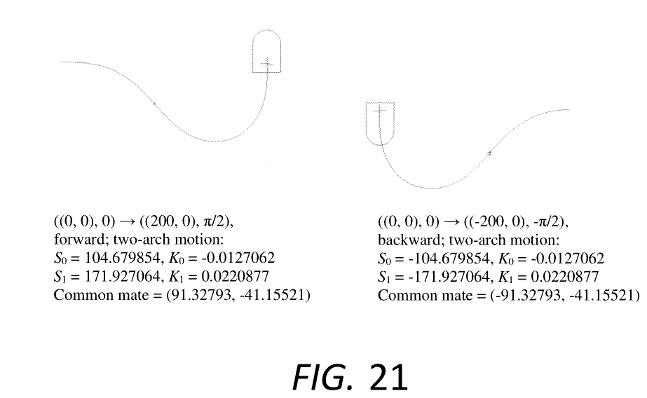

The main task of the parking motion algorithm is to drive a vehicle from start to goal, where
start=(p₀, θ₀)=((x₀, y₀), θ₀)=((0, 0), 0), which is a constant, and
goal=(p₁, θ₁)=((x₁, y₁), θ₁), which is given by a user or determined by a processor, based upon sensor input,
using a motion of one or two arch curves with minimal motion cost. (FIG. 20)

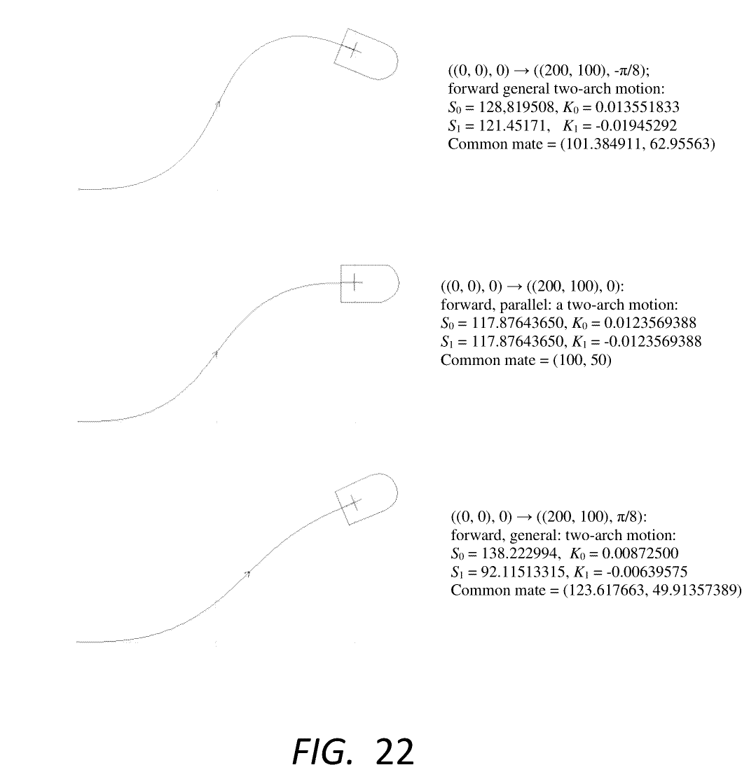

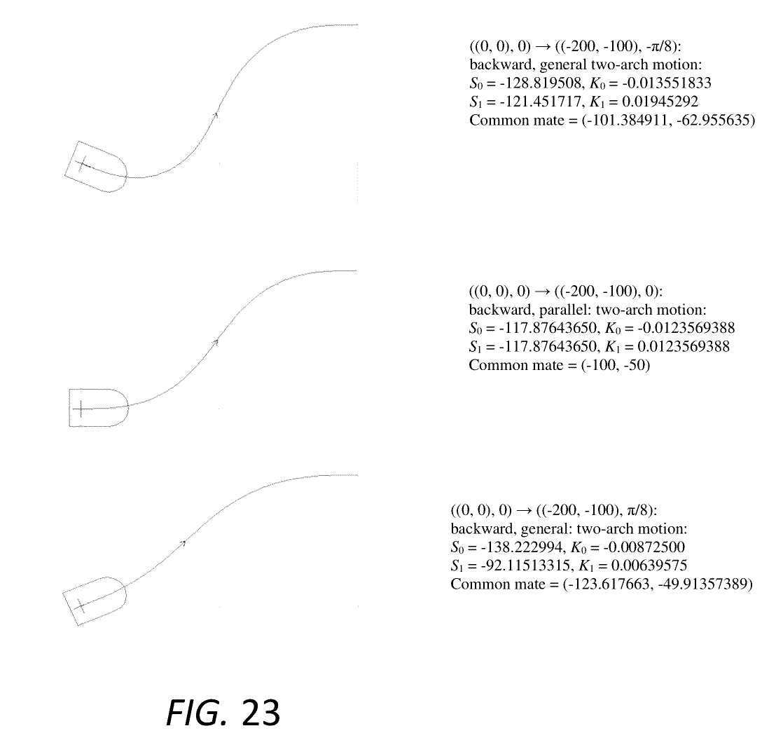

Exemplary parking motions in general cases are as follows:
FIG. 21: Forward motion at left and backward motion at right.
FIG. 22: Three forward motions
FIG. 23: Three backward motions

### 16. Car-Like Vehicle

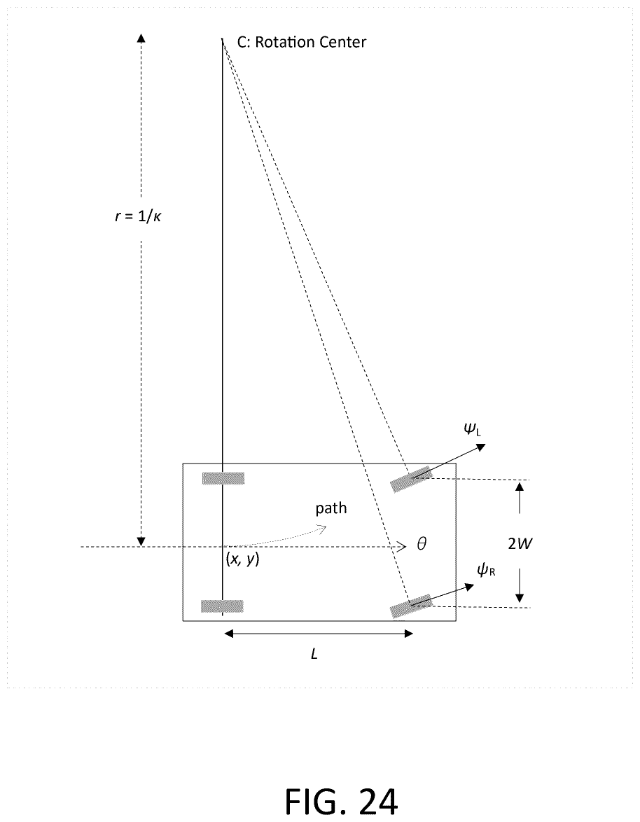

We install this teaching in an exemplary vehicle, a car-like vehicle. This vehicle has two rear wheels and two front wheels. (FIG. 24) The rear wheels drive the vehicle with v, a commanded velocity. Let the front wheels' directions be

$${ψ}_{L} = tan ( \frac{L}{r - W} ) = tan ( \frac{κ L}{1 - κ W} ) \qquad ( 16.1 )$$

$${ψ}_{R} = tan ( \frac{L}{r + W} ) = tan ( \frac{κ L}{1 + κ W} ) \qquad ( 16.2 )$$

Notice that r=1/k. If x<0, the center C of rotation is at the bottom side of FIG. 24. Therefore, the vehicles' steering embodies the commanded motion (v, k).

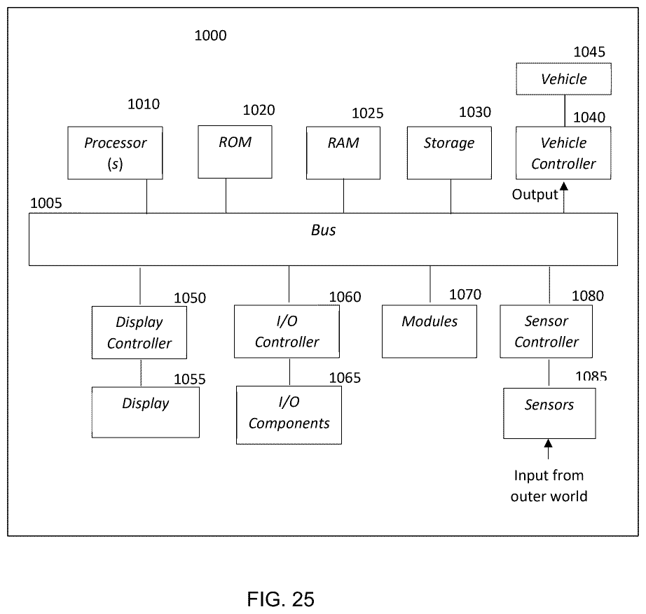

We assume a vehicle controller in FIG. 25 can execute an arch motion. The main algorithm passes two parameters (S, K) as an output to the controller, which executes an arch motion:

$$κ ( s ) = K sin ( π s / S ) , 0 \leq s \leq S or S \leq s \leq 0$$

FIG. 25 illustrates an exemplary block diagram of a computer system that executes this teaching. A computing system 1000 that can be used in conjunction with one or more of the embodiments described herein. The illustrated computing system 1000 can represent any of the devices or systems (e.g.

vehicle control system, engine control system, vision system, etc.) described herein that perform any of the processes, operations, or methods of the disclosure. Note that while the computing system 1000 illustrates various components, it is not intended to represent any particular architecture or manner of interconnecting the components as such details are not germane to the present disclosure. It will also be appreciated that other types of systems that have fewer or more components than shown may also be used with the present disclosure.

As shown, the computing system 1000 can include a bus 1005 which can be coupled to one or more processors 1010, ROM 1020 (Read Only Memory), RAM 1025 (or volatile memory), and storage 1030 (or non-volatile memory). The processor(s) 1010 can retrieve stored instructions from one or more of the memories (e.g., ROM 1020, RAM 1025, and storage 1030) and execute the instructions to perform processes, operations, or methods described herein. These memories represent examples of a non-transitory machine-readable medium (or computer-readable medium) or storage containing instructions which when executed by a computing system (or a processor), cause the computing system (or processor) to perform operations, processes, or methods described herein. The RAM 1025 can be implemented as, for example, dynamic RAM (DRAM), or other types of memory that require power continually in order to refresh or maintain the data in the memory. Non-volatile memory (e.g., storage 1030) can include, for example, magnetic, semiconductor, tape, optical, removable, non-removable, and other types of storage that maintain data even after power is removed from the system. It should be appreciated that the non-volatile memory can be remote from the system (e.g. accessible via a network).

A display controller 1050 can be coupled to the bus 1005 in order to receive display data to be displayed on a display device 1055, which can display any one of the user interface features or embodiments described herein and can be a local or a remote display device. The computing system 1000 can also include one or more input/output (I/O) components 1065 including mice, keyboards, touch screen, network interfaces, printers, speakers, and other devices. Typically, the input/output components 1065 are coupled to the system through an input/output controller 1060.

Modules 1070 can represent any of the functions or engines described above, including components, units, functions, or logic. Modules 1070 can reside, completely or at least partially, within the memories described above, or within a processor during execution thereof by the computing system. In addition, modules 1070 can be implemented as software, firmware, or functional circuitry within the computing system, or as combinations thereof. In some embodiments, the functions described herein can utilize specialized hardware circuitry (or firmware) of the system.

In various embodiments, the input/output components 1065 and/or modules 1070 can include one or more vehicle sensors. In some embodiments, the input/output components 1065 and/or modules 1070 can further include global positioning system (GPS), accelerometers, inertial measurement units, gyroscopes, shaft rotational sensors, torque sensors, deflection sensors, pressure sensor, and flow sensors.

In one embodiment, the system 1000 includes a sensor controller 1080 and one or more sensors 1085. The sensors can be radar-based, an inertial motion unit, an ultrasonic sensor, a proximity sensor, a camera, a stereo vision, and a lane sensor. In some embodiments, the sensors are sonar sensors. The sensors 1085 may be configured to receiving information about objects and driving boundaries proximate to the vehicle 1045.

The system 1000 may include a vehicle controller 1040. The vehicle controller 1040 may be used to control the vehicle as described hereinabove with respect to the single arch or double arch motion. In one embodiment, the single arch or double arch motion is executed using the vehicle controller 1040 to control the vehicle 1045 using the calculated S, K variables described hereinabove. The vehicle controller 1040 may be configured to control the vehicle 1045 using a Cartesian coordinate system.

In one embodiment of the system 1000, the system 1000 receives location-based information associated with objects to avoid, e.g., other vehicles, driving boundaries e.g., center lines, walkways, curb positions. In some embodiments, the system 1000 may be configured to receive location-based information associated with objects to avoid and driving boundaries within a Cartesian coordinate system associated with a proximate location to the vehicle 1045. In some embodiments, the system 1000 may be configured to calculate location-based information associated with objects to avoid driving boundaries within a Cartesian coordinate system proximate to the vehicle 1045 using one or more known techniques.

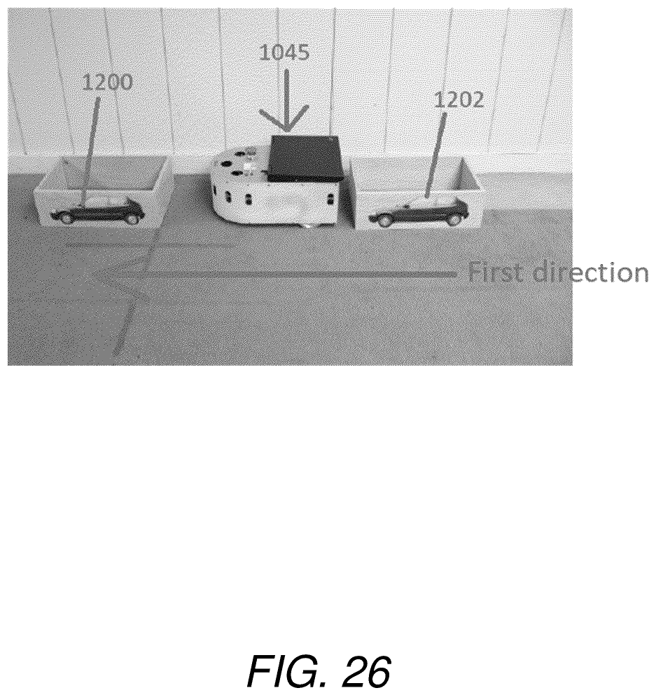

In use, with reference here to FIG. 26, an example is provided to illustrate the teachings herein. As shown in FIG. 26, we consider a situation where the vehicle must park on this mockup street, in a rear of a first vehicle 1200 and front of a second vehicle 1202, i.e., a parallel parking event. First, the vehicle drives in a first direction as shown in FIG. 26 while the vehicle's sonar 1085 scans other vehicles and the curb and determines the x-coordinate of the front end of the second vehicle 1202, the Y-coordinate of the curb, and the rear end of first vehicle 1200. System 1000 performs a safety check to see whether enough space between vehicles 1200 and 1202 exists to safely fit vehicle 1045.

If enough space exists, vehicle 1045 stops in a safe and legal position near vehicle 1200 and defines its frame as start=q₀=((x₀, y₀), θ₀)=((0, 0), 0) in FIG. 26. The system 1000 computes a goal=q₁=(((x₁, y₁), θ₁), based upon the received information from the prior scanning, wherein, x₁<0.

The system 1000, including the processor 1010, calculates a single arch or double arch motion using the teachings herein. Finally, the vehicle 1045 executes a parallel-parking motion from the start frame to the goal frame, using instructions provided by the processor 1010, along the calculated single arch or double arch motion.

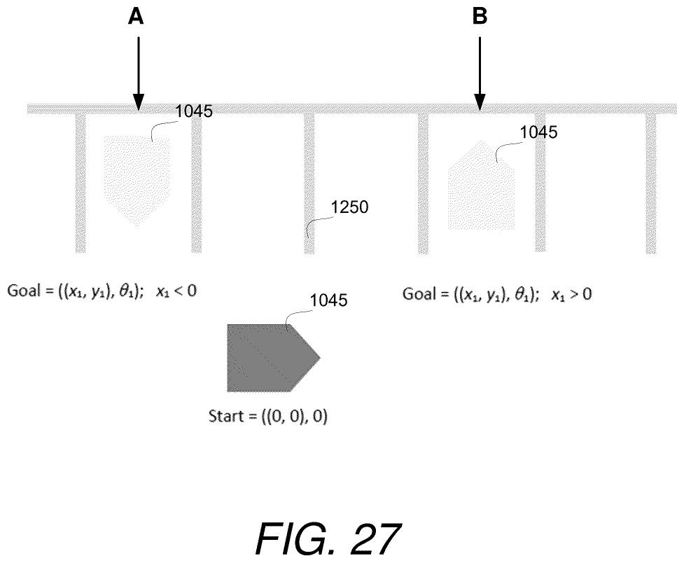

FIG. 27 shows another exemplary situation. As FIG. 27 shows, a vehicle 1045 begins in an initial starting position. The vehicle may park between any of the parking lot lines 1250. In one event, vehicle 1045 may execute a calculated single arch or double arch motion to make a backward parking motion into parking spot ‘A’, as shown. In one event, vehicle 1045 may execute a calculated single arch or double arch motion to make a forwards parking motion into parking spot ‘B’, as shown.

Before executing a single arch or double arch motion, the system 1000 can survey the parking lot using one or more sensors 1085. In one embodiment, these sensors 1085 are stereo vision sensors. The system 1000 can then detect the position and direction of each parking lot line 1250. In one embodiment, system 1000 uses a two-dimensional transformation theory to process and define parking lot lines 1250. Furthermore, the frame ((x₁, y₁), θ₁) of an empty parking slot for a vehicle is obtained if such a slot exists.

FIG. 27 shows another exemplary situation. As FIG. 27 shows, vehicle 1045 begins in an initial starting position. The vehicle may park between any of the parking lot lines 1250. In one event, vehicle 1045 may execute a single arch or double arch motion to make a backward parking motion into parking spot ‘A,’ as shown. In one event, vehicle 1045 may execute a single arch or double arch motion to make a forward parking motion into parking spot ‘B,’ as shown.

If x₁>0, the empty slot sits front of the vehicle, which moves forward into the slot head-in. If x₁<0, the empty slot is on the back side of the vehicle, which moves backward into the slot. In either case, the vehicle motion is created by this teaching: from start to goal.

In one embodiment of the system 1000, the processor 1010 receives a parking category type, which may be either: (1) parallel-parking type; (2) a forward-parking type; or (3) a backward-parking type. Each parking category type may be associated with a set of pre-defined visual objects to position in the coordinate system and safety tasks to comply with before executing a marking motion. In one embodiment, the parking category type may be supplied by a user-driver using a known I/O device into the system 1000.

In the case of a forward-parking category type, the processor 1010 may control the vehicle 1045 into a parking lot. The system 1000 uses the sensors 1085 to scan for an empty slot bounded by two parallel white lines such as shown in FIG. 27. The vehicle's present frame can be defined as ((x₀=0, y₀=0), θ₀=0). The processor 1010 calculates a position and direction of slot as a goal position and direction (p₁, θ₁)=((x₁, y₁), θ₁). (x₁>0) using information received from the sensors 1085.

In the case of a backward-parking category type, the processor 1010 may control the vehicle 1045 into a parking lot. The system 1000 uses the sensors 1085 to scan for an empty slot bounded by two parallel white lines such as shown in FIG. 27. The processor 1010 calculates a position and direction of slot as a goal position and direction (p₁, θ₁)=((x₁, y₁), θ₁). (x₁<0) using information received from the sensors 1085.

The various features of the different embodiments or examples may be variously combined with some features included and others excluded to suit a variety of different applications. Examples may include subject matter such as a method, means for performing acts of the method, at least one machine-readable medium including instructions that, when performed by a machine cause the machine to perform acts of the method, or of an apparatus or system according to embodiments and examples described herein. Additionally, various components described herein can be a means for performing the operations or functions described herein.

One embodiment provides an electronic device, comprising a non-transitory machine-readable medium to store instructions; one or more processors to execute the instructions; and a memory coupled to the one or more processors, the memory to store the instructions which, when executed by the one or more processors, cause the one or more processors to create motion for an autonomous vehicle.

### VARIABLES AND THEIR MEANINGS

p=(x, y) is a position.

θ is a direction.

(p, θ) is a frame.

p₀=(x₀, y₀)=(0, 0) is the starting position of the vehicle.

θ₀=0 is the starting direction of the vehicle.

p₁=(x₁, y₁) is a goal position.

θ₁ is a goal direction.

s is an arc length of vehicle trajectories.

S and S₀ are the total arc lengths of vehicle trajectories.

k(s), 0≤s≤S or S≤s≤0 is a curve.

k(s)=K sin (πs/S), 0≤s≤S or S≤s≤0 is an arch.

S, S₀, and S₁ are the total arc lengths of a curve.

A vehicle's orientation is either forward or backward, depending on the value of ₁.

If the vehicle's orientation is forward, the vehicle produces a forward motion, and s, S, S₀, and S₁>0. Otherwise, the vehicle produces a backward motion, and s, S, S₀, and S₁<0.

θ(s) is the direction of a curve at s.

p(s) is the position of a curve at s.

θ₀=θ(0) and p₀=p(0) for an arch,

θ₁=θ(S) and p₁=p(S) for an arch.

φ is the end angle of an arch, θ₁-θ₀.

K, K₀, and K₁ are the maximum curvature of an arch.

(S, K) is an arch, where S is the total arclength, and K is the maximum curvature.

The cost of a path k=k(s), 0≤s≤S is equal to Γ(k(s))=∫₀^{s}(dk(s)/ds)²ds.

The cost of an arch (S, K) is equal to (π⁴/8) (φ²/S³), where S is the total arclength, and φ is the end angle.

The function distance (a, b) means the distance between a position a and a position b.

D is equal to distance (p₀, p₁) in an arch called a cord.

Σ(φ) is the arch-cord ratio at φ, S/D.

Let q₀=(p₀, θ₀) and q₁=(p₁, θ₁) be two frames with p₀≠p₁, and let α be the direction from position p₀ to position p₁. If (α-θ₀)+(α-θ₁)=0 holds, we call the frame pair <q₀, q₁> a mate. (FIG. 4)

<q_{A}, q_{B}> means that frames q_{A} and q_{B} form a mate.

If <q_{A}, q_{B}> and <q_{B}, q_{C}> are mates, q_{B} is called a common mate (or inflection) of q_{A} and q_{C}.

The cost of a curve k=k(s), 0≤s≤S is calculated by: Γ(k(s))=∫₀^{s}(dk(s)/ds)²ds.

The cost of an arch, (S, K), is calculated by (π⁴/8) (φ²/S³), where S is the total arc length and φ is the end angle.

P is the pivot (x_{P}, y_{P}) of start and goal.

Pivot circle is defied by P and start position and start direction and goal position and goal direction.

Let p₂ be an arbitrary point on the pivot circle, α₀ be the line from p₀ to p₂, and α₁ be the line from p₂ to p₁, as shown in FIG.18. Then, q₂=(p₂, θ₂)=(p₂, 2α₀-θ₀,) is a common mate of start q₀ and goal q₁.

μ is the direction from P to the above p₂ or inflection point.

Cost2(μ) is the total cost Cost(arch(<q₀, q₂>))+Cost(arch(<q₂, q₁>)).

getLeastCostCommonMate (start, goal) is a function that finds a common mate (inflection) that minimizes the total cost Cost2(μ).

Relations between K, S, and φ in an arch are KS=πφ/2 and φ=2KS/π.

α is the direction (p₀, p₁) in an arch. (FIG. 8)

P is the pivot (x_{P}, y_{P}) of start and goal.

ψ is one-half of the end angle φ, equal to (θ₁-θ₀)/2.

α₀ is the direction from p₀ to p₂.

α₁ is the direction from p₂ to p₁.

r is the radius of the common-mate circle.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. A method for controlling an autonomous vehicle during a parking motion, comprising:
receiving information, into a processor onboard the vehicle, from at least one sensor;
calculating, via a processor onboard the vehicle, a starting vehicle position and a vehicle direction as (p₀, θ₀)=((x₀=0, y₀=0), 0);
calculating, via the processor onboard the vehicle, a goal parking position and a goal parking direction as (p₁, θ₁)=((x₁, y₁), θ₁) based upon the received information from the sensor, wherein x₁ is not equal to 0;
calculating, via the processor onboard the vehicle, a single arch or double arch motion based upon the starting vehicle position, the starting vehicle direction, the goal parking position, and the goal parking direction; and
controlling the vehicle, via instructions provided by the processor onboard the vehicle, based upon the calculated single arch or double arch motion and the received information from the at least one sensor.

2. The method of claim 1, further comprising:
comparing the starting vehicle position and the starting vehicle direction with the goal parking position and the goal parking direction to determine if they are a mate;
if they are a mate, then obtain an arch (S, K) using the following calculation:
calculating φ=θ₀−θ₀;
calculating D=distance (p₀, p₁);
calculating S=D Σ(φ), wherein Sis a total arc length of the arch (S, K);
if (x₁<0) calculating S=−S;
calculating K=πφ/(2S), wherein K is a maximum curvature of the arch (S, K); and
further controlling the vehicle based upon the calculated arch (S, K).

3. The method of claim 1, further comprising:
comparing the starting vehicle direction θ₀ and the goal parking direction θ₁, wherein if θ₀=θ₁, then:
calculating α=tan⁻¹ ((y₁−y₀)/x₁);
calculating an inflection position p₂=((x₀+x₁)/2, (y₀+y₁)/2);
calculating the inflection direction=θ₂=2α−θ₀;
calculating φ₁=θ₂−θ₀;
calculating D₁=distance (p₀, p₂);
calculating S₁=D₁ Σ(φ₁);
if (x₁<0) calculating S₁=−S₁;
calculating K₁=πφ₁/(2S₁);
further controlling the vehicle with (S₁, K₁);
calculating φ₂=θ₁−θ₂;
calculating D₂=distance (p₂, p₁);
calculating S₂=D₂ Σ(φ₂);
if (x₁<0) calculating S₂=−S₂;
calculating K₂=πφ₂/(2S₂); and
further controlling the vehicle based upon the calculated (S₂, K₂).

4. The method of claim 1, further comprising:
comparing the starting vehicle position and the goal parking position, wherein if the starting vehicle position and direction and the goal parking position and direction are not a mate and the starting vehicle direction 00 and the goal parking direction θ₁ are not equal, then:
calculating a pivot position of the starting vehicle position and the starting vehicle direction and the goal parking position and the goal parking direction;
calculating a common mate circle based upon the starting vehicle position and the starting vehicle direction and the goal parking position and the goal parking direction and the calculated pivot position;
searching for an inflection q₂=(p₂, θ₂) on the common mate circle that minimizes the total cost Cost2 (μ)=Cost (arch (<q₀, q₂>))+Cost (arch (<q₂, q₁>)), wherein μ is a direction from the pivot position to the inflection;
further controlling the vehicle to execute a two-arch motion comprising of arch (<q₀, q₂>)) and arch (<q₂, q₁>);
calculating φ₁=θ₂−θ₀;
calculating D₁=distance (p₀, p₂);
calculating S₁=D₁ Σ(φ₁);
if (x₁<0) calculating S₁=−S₁;
calculating K₁=πφ₁/(2S₁);
further controlling the vehicle with (S₁, K₁);
calculating φ₂=θ₁−θ₂;
calculating D₂=distance (p₂, p₁);
calculating S₂=D₂ Σ(φ₂);
if (x₁<0) calculating S₂=−S₂;
calculating K₂=πφ₂/(2S₂); and
further controlling the vehicle with (S₂, K₂).

5. The method of claim 1, further comprising:
further controlling the vehicle based upon a cost of a motion, wherein the cost of the motion, k=k(s), 0≤s≤S is calculated by:
$$Γ ( κ ( s ) ) = {\int }_{0}^{S} {( d κ ( s ) / ds )}^{2} ds$$
wherein s represents an arc length associated with the vehicle's trajectory.

6. The method of claim 1, further comprising:
further controlling the vehicle based upon a cost of an arch, wherein the cost of an arch, (S, K), is calculated by:
$$( S , K ) = ( {π}^{4} / 8 ) ( {φ}^{2} / {S}^{3} )$$
wherein S is the total arc length and φ is an end angle.

7. The method of claim 1, further comprising:
calculating, via the processor onboard the vehicle, and the received sensor information, parking lane positions and determining if safe and compliant; and
further controlling the vehicle based upon the calculated parking lane positions.

8. The method of claim 7, further comprising:
receiving a parking category type, wherein the parking category type is one of: (1) a parallel-parking type; (2) a forward-parking type; or (3) a backward-parking type; and
further controlling the vehicle, using instructions received from the processor, based upon the received parking category type.
